(19) United States
(12) Patent Application Publication
(10) Pub. No.: US 2003/0097858 A1
(43) Pub. Date: May 29, 2003

(54) Silver sensitized erbium ion doped planar waveguide amplifier

(76) Inventors: Christof Strohhofer, Amsterdam (NL); Albert Polman, Amsterdam (NL)

Correspondence Address: SKJERVEN MORRILL LLP, 25 METRO DRIVE, SUITE 700, SAN JOSE, CA, 95110, US

(21) Appl. No.: 09/994,578

(22) Filed: Nov. 26, 2001

(51) Int. Cl. C03C 25/60; C03C 21/00

(52) U.S. Cl. 65/390; 65/30.13

(57) ABSTRACT

A material for use in optical amplifiers is described. The material includes an oxide glass substrate material, a rare earth dopant and a silver dopant. The silver dopant enhances photoluminescence of the rare earth dopants in the oxide glass. The silver can be introduced into the glass using an ion exchange process or by ion implantation. Oxide glass doped with erbium ions and silver ions provides a broad excitation band for photoluminescence of Er³⁺ in the visible and near ultraviolet. An amplifier material according to the present invention can be formed by ion implanting a rare earth ion, for example erbium, and doping with silver by an ion exchange method. Alternatively, the silver can be implanted into the material as well. The resulting silver dopant may be dispersed throughout the oxide glass primarily as ions as a result of the fabrication method.

### BACKGROUND

1. Field of the Invention

The present invention relates to optical amplifier materials and, in particular, to formation of an optical amplifier material with enhanced pump efficiency.

2. Discussion of Related Art

Optical amplifiers incorporating rare earth ions as dopants are in wide use today, especially for Dense Wavelength-division Multiplexing (DWDM) applications. In a conventional optical amplifier, a pump laser is used to populate one or more of the excited states of the rare earth ion. An optical signal having an appropriate wavelength entering the amplifier stimulates the emission of photons at the same wavelength as the incoming optical signal by causing electrons in the populated electron states to drop to a lower energy state.

A conventional optical amplifier employs erbium ions as the dopant material. Typically, a pump laser provides 980 nm light which is injected into the length of an erbium-doped fiber and populates an excited state of the erbium ions. An incoming signal with a wavelength 80 about 1550 nm (in the “conventional” or “C” band) stimulates emission of photons of wavelength λ from the excited erbium ions.

However, populating the excited state of the rare earth atoms is generally an inefficient process since the absorption cross section of such rare earth ions is small. For example, the absorption cross section of erbium for 980 nm light is approximately 2×10⁻²¹. With such a small absorption cross section, a large photon density is needed to populate the excited states of a sufficient number of rare earth ions to achieve the desired signal amplification. Due to the need for the large photon density, a pump source with high power is required.

Further, since the excitation band of the erbium is narrow, a laser is generally required. A material that would allow for broad band excitation of the rare earth ions may eliminate the need for a pump laser and thus decrease the cost of amplification.

A number of methods have been proposed to increase the excitation efficiency of rare earth ions. For erbium, codoping with ytterbium has been used in optical amplifiers for 1540 nm light (see, for example, P. Laporta, S. De Silvestri, V. Magni, and O. Svelto, Optics Letters 16, 1952 (1991) and D. Barbier et al., IEEE Photonics Technology Letters 9, 315 (1997)). Additionally, others have been working to develop broad-band sensitization in the visible via organic complexes dissolved in a polymer (see, for example, L. H. Slooff et al., Journal of Applied Physics 83, 497 (1998)) and silicon nanocrystals (see, for example, M. Fujii, M. Yoshida, Y. Kanzawa, S. Hayashi, and Yamamoto, Applied Physics Letters 71, 1198 (1997)). The sensitization effect of Yb is relatively limited, organic complexes show photodegradation and low quantum efficiency, and the fabrication of Si nanocrystals is not always compatible with standard waveguide processing.

Additionally, several absorption and emission bands in the visible and near ultraviolet related to silver have been observed in glasses. See, e.g., M. Mesnaoui, M. Maazaz, C. Parent, B. Tanguy, and G. Le Flem, European Journal of Solid State Inorganic Chemistry 29, 1001 (1992); A. Meijerink, M. M. E. van Heek, and G. Blasse, Journal of Physics and Chemistry of Solids 54, 901 (1993). Silver can be introduced in concentrations of several atomic percent into glasses via an ion exchange process, see, e.g., R. V Ramaswamy and R. Srivastava, Journal of Lightwave Technology 6 984 (1988). It is therefore desirable to provide an amplifier that can be excited by a broadband source, which may eliminate the need for a pump laser altogether and significantly reduce the cost of amplification. Further, a fabrication method for co-doping an amplifier material with silver and erbium with a high efficiency energy transfer between the silver and the erbium ions is desirable, which may reduce the pump power requirement if a pump laser is still used for excitation.

### SUMMARY OF THE INVENTION

In accordance with the present invention, optical amplifier materials with high efficiency coupling between co-doped ions are presented. In some embodiments, the optical amplifier material may include rare earth ions, such as erbium, co-doped with, for example, silver ions. In some embodiments, the optical amplifier material may be deposited on a substrate material suitable for use as a fiberoptic planar waveguide core.

According to an embodiment of the invention, a method of fabricating an amplifier material is presented. In some embodiments, the fabrication includes ion implantation of a rare earth ion, for example erbium, and doping by ion exchange with a co-dopant, for example silver. In some embodiments, the fabrication includes ion implantation of a rare earth ion, for example erbium, and doping by ion implantation of a co-dopant, for example silver.

In some embodiments, the method may include providing a glass material, for example an oxide glass material, doping the glass material with a rare earth ion, for example erbium, then providing silver ions for enhanced emission of the rare earth ion. The material may include silver dopants in the form of nano-crystals; however, the silver is preferably dispersed primarily as ions in the glass material.

The resulting amplifier, then, includes rare-earth ions and a co-dopant ion. In some embodiments, the amplifier includes glass doped with erbium and silver ions, where the silver ions are dispersed throughout the glass primarily as ions. This increases the pump efficiency greatly. In some embodiments, the luminescence from Erbium ions can be increased up to a factor of 70 in amplifier materials according to the present invention, as compared to the luminescence from Erbium ions obtained without silver co-doping.

According to another embodiment of the invention, an optical amplifier is described. The optical amplifier includes a cladding region and a core region. Optical amplifiers are well known. The core may include an oxide glass doped with a rare earth ion. The core may also include silver ions in order to increase the emission of the rare earth ion and thus improve the amplification of the device.

According to another embodiment of the invention, a method for making an optical amplifier is described. The optical amplifier includes a cladding region and a core region. Methods of making optical amplifiers are well known.

According to another embodiment of the invention, a planar optical device is described, where the device includes a lower cladding layer, a core portion, and an upper cladding layer. The core portion has a higher index of refraction than the upper and lower cladding layers. Planar optical devices are well known. Additionally, the core portion includes a rare earth dopant and a silver dopant.

According to another embodiment of the invention, a method for making a planar optical device is described. The method includes providing a first cladding layer, depositing a core layer, doping the core layer, and depositing an upper cladding layer. The core portion has a higher index of refraction than the upper and lower cladding layers. Methods of making planar optical devices are well known. Additionally, the core portion includes a rare earth dopant and a silver dopant.

### SHORT DESCRIPTION OF THE FIGURES

FIG. 1 shows a process for making a material including borosilicate glass in the form of a BK7 wafer doped with erbium and silver, where very little of the silver is in nanocrystals.

FIG. 2 shows a process for making a material including borosilicate glass doped with erbium and silver, where some of the silver is in nanocrystals.

FIG. 3 shows spectra of Er³⁺ emission in BK7 doped with silver by an ion exchange process.

FIG. 4 shows excitation spectra of erbium and silver codoped BK7 in the near ultraviolet and visible, where the inset shows an excitation spectrum of Er³⁺ in BK7 without silver for comparison (note difference in scale).

FIG. 5 shows excitation spectra of erbium and silver codoped BK7 overlaying the absorbance induced by the ion exchange, ion irradiation and thermal treatment for silver ion exchange after ion irradiation and for Er implantation after silver ion exchange.

### DETAILED DESCRIPTION

Doping oxide glasses with silver can enhance photoluminescence of rare earth dopants in the oxide glasses. Silver can be introduced into glasses, for example, via an ion exchange process in which sodium or potassium ions in the glass are interchanged for silver ions. Alternatively, silver can be introduced into the glass via an ion implant process. Rare earth dopants can include erbium, ytterbium, thulium, praseodymium, neodymium, and dysprosium. Some combinations of two or more dopants may be used.

An amplifier material formed from oxide glass doped with erbium ions and silver ions, for example, provides a broad excitation band for photoluminescence of Er³⁺ in the visible and near ultraviolet. At 488 nm, a wavelength that can be absorbed directly by the erbium ions, some embodiments of the material can provide luminescence enhancements up to a factor of 70 over the luminescence obtained by exciting the ⁴F_{7/2} state of Er³⁺ in a similar material without a silver co-dopant.

Silver dopants may be dispersed throughout the oxide glass primarily as ions or primarily in the form of nanocrystals. Embodiments of the invention in which there are few or no silver nanocrystals provide the greatest photoluminescence enhancement. Embodiments of the invention in which the silver was primarily (though not exclusively) dispersed as nanocrystals provided less enhancement. However, embodiments of the invention in which the silver is primarily dispersed as nanocrystals still provide significant photoluminescence enhancement.

Although photoluminescence can be enhanced in the material described here when using a pump laser as an excitation source as in a conventional amplifier, a pump laser is not necessary. For example, some of the luminescence enhancements described here were obtained using a xenon lamp as an excitation source. Therefore, a pump laser may not be required when using an optical amplifier made from an oxide glass doped with erbium and silver ions and thus amplification systems may be less expensive, easier to manufacture, and easier to align than a conventional optical amplifier.

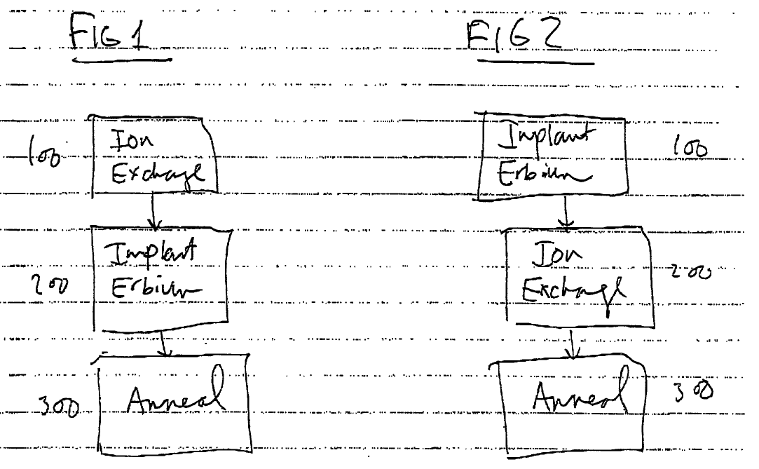

FIG. 1 illustrates a method of fabrication an amplifier material according to some embodiments of the invention. Sample optical amplifier materials according to an embodiment of the current invention were prepared using a borosilicate glass (BSG) substrate. The BSG substrate used was a 1 mm thick Schott BK7 wafer.

In preparing a first sample optical amplifier material according to an embodiment of the invention, the BSG substrate was processed as shown in FIG. 1. First, silver was introduced into the sample by a Na⁺→Ag⁺ ion exchange in a salt melt containing 5 mol % AgNO₃ and 95 mol % NaNO₃. The samples were left in the melt for 7 minutes at 310° C. Erbium was then ion implanted into the samples at an energy of 925 keV to a fluence of 3.1×10¹⁵ cm⁻². The sample was then annealed in vacuum for 30 minutes at 350° C.

Performing the ion-exchange before the erbium implant promotes the formation of silver nanocrystals. Therefore, the sample prepared using the process of FIG. 1 has a higher concentration of silver nanocrystals and less silver in the form of Ag⁺ ions dispersed throughout the glass. Rutherford Backscattering Spectrometry indicated that the silver concentration in the first sample was about 2.2 at. %.

In preparing a second sample optical amplifier material according to another embodiment of the invention, the BSG substrate was processed as shown in FIG. 2. The process steps shown in FIG. 2 are the same as those in FIG. 1 and described above, except in FIG. 2 the erbium implant step is performed before the ion exchange process.

Using this preparation method, the silver was present predominantly as Ag⁺ ions dispersed in the glass matrix, not as nanocrystals. Rutherford Backscattering Spectrometry indicated that the silver concentration in the second sample was about 3 at. %.

A reference sample was prepared without the ion exchange process; that is, with an erbium implant but without an ion exchange to incorporate a silver dopant. Like the first and second samples, the reference sample was annealed in vacuum for 30 minutes at 350° C.

Normal incidence transmission spectra were measured using a Varian Cary 5 photospectrometer in the wavelength range between 300 nm and 2000 nm. An untreated glass slide was placed in the reference beam to only measure changes in the transmission spectrum due to the various sample treatments. Photoluminescence of Er³⁺ was excited with the lines of an Ar⁺ laser, dispersed with a 96 cm monochromator and detected with a liquid nitrogen-cooled germanium detector. Photoluminescence excitation spectra were measured using a xenon lamp as excitation source and a monochromator with 20 nm spectral resolution for wavelength selection.

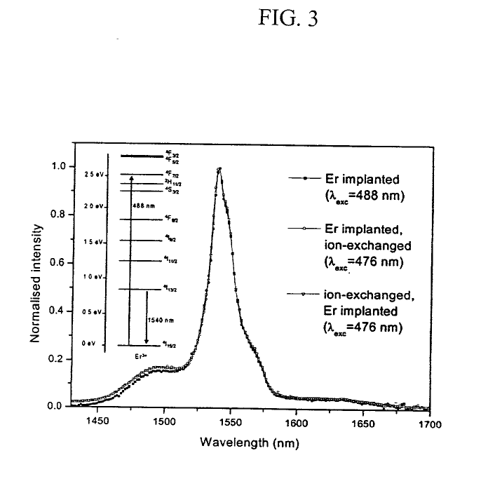

FIG. 3 shows the emission spectra between 1400 nm and 1700 nm of the first and second samples and the reference sample. The emission lines are caused by the transition between the first excited state and the ground state of Er³⁺ and are essentially identical for the three samples. However, the reference sample was excited with 488 nm light, which corresponds to the ⁴F_{7/2} state of Er³⁺. The first sample and second sample were excited instead with 476 nm light, which is a wavelength that is not directly absorbed by Er³⁺.

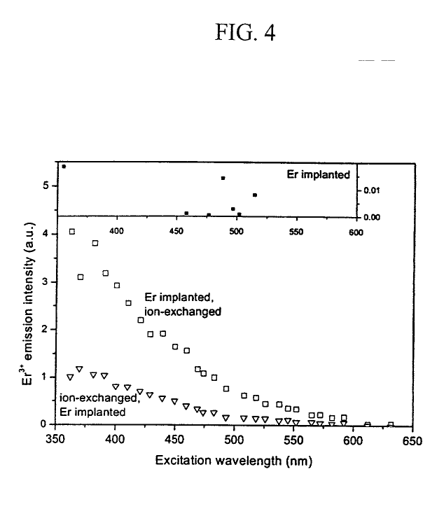

The main plot of FIG. 4 shows the excitation spectra of the first and second samples, while the inset to FIG. 4 shows the excitation spectrum of the reference sample, where the scale of the inset is appreciably different from the scale of the main figure. The shape of the excitation spectrum is essentially identical for the first sample and the second sample and illustrates that a wide spectral range can be used to excite erbium when silver dopants are used, for example, from the near ultraviolet to the red. However, FIG. 4 shows that the intensity of the Er³⁺ emission is higher for the second sample, which underwent the ion exchange after implantation of erbium and in which the silver is predominantly dispersed in ionic form in the glass matrix.

As can be seen from the inset to FIG. 4, the reference sample (without silver dopants) shows significant emission only when the excitation wavelength is one absorbed by the erbium ions. The spectrum of erbium in the reference sample was obtained using an Ar⁺ ion laser to excite the erbium ions, since the absorption cross sections of the intra-4f transitions of Er³⁺ are too small to lead to detectable emission when excited with a xenon lamp. As FIG. 4 illustrates, even at 488 nm the emission intensity is enhanced by a factor of 20 for the first sample and by a factor of 70 for the second sample over the emission intensity of the reference sample (note the difference in scale between the main plot and the inset).

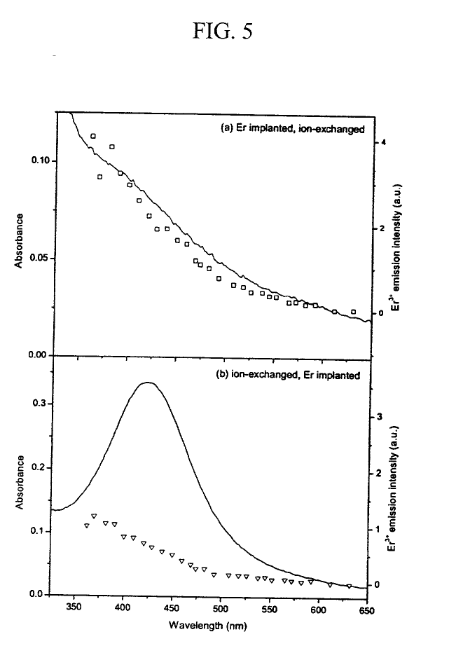

FIG. 5 shows the excitation spectra together with the corresponding absorbance spectra. This shows that although the second sample (where most or all of the silver is dispersed as ions throughout the glass matrix) provides for superior excitation of erbium, both the first and second samples allow broadband excitation of the erbium due to the presence of silver dopants.

The enhancement of Er³⁺ emission by codoping with silver is not restricted to doping by ion exchange. In some embodiments of the invention, silver doping is accomplished by ion implantation rather than ion exchange. Providing silver dopants by ion implantation rather than ion exchange results in a broad excitation band for the photoluminescence of Er³⁺.

The embodiments described herein are illustrative only and are not intended to be limiting. One skilled in the art may determine several variations which are intended to be within the scope of this disclosure. As such, the invention is limited only by the following claims.

We claim:

1. A method for making an optical amplifier material, said method including:
providing a glass material;
doping said glass material with a rare earth dopant, wherein said doping includes ion implantation of said rare earth dopant; and
doping said glass material with a silver dopant.

2. The method of claim 1, wherein doping said glass material with said silver dopant includes ion implantation of said silver dopant.

3. The method of claim 1, wherein doping said glass material with said rare earth dopant is performed before doping said glass material with said silver dopant.

4. The method of claim 1, wherein doping said glass material with said silver dopant is performed before doping said glass material with said rare earth dopant.
